(19) United States
(12) Patent Application Publication
(10) Pub. No.: US 2002/0095609 A1
(43) Pub. Date: Jul. 18, 2002

(54) Multiprocessor apparatus

(76) Inventor: Yuichi Tokunaga, Tokyo (JP)

Correspondence Address: BIRCH STEWART KOLASCH & BIRCH, PO BOX 747, FALLS CHURCH, VA, 22040-0747, US

(21) Appl. No.: 09/895,151

(22) Filed: Jul. 2, 2001

(30) Foreign Application Priority Data
Jan. 15, 2001 (JP) P2001-006251

(51) Int. Cl. G06F 1/26; G06F 1/28; G06F 1/30

(52) U.S. Cl. 713/300

(57) ABSTRACT

A multiprocessor apparatus includes a high speed processor coupled to a high speed bus, a low speed processor coupled to a low speed bus, a bus adapter for coupling between the high speed bus and the low speed bus, an operating system for determining as to at which processor application program is to be executed, and an activation controller for activating clock signal for the processor which executes the application program, based on the determination result of the operating system.

### BACKGROUND OF THE INVENTION

1. Field of the Invention

The present invention relates to a multiprocessor apparatus used in information processing apparatuses such as portable telephones, notebook computers etc. and LSIs which are required to be low in a dissipation power.

2. Description of the Related Art

As a method of reducing a dissipation power of an information processing apparatus, there is a method of employing a means for reducing the frequency of a clock signal or a voltage applied thereto.

FIG. 7 is a functional constitutional diagram showing a low dissipation power means in a conventional microcomputer disclosed in Japanese Patent Laid-Open No. 211960/1996, for example. In FIG. 7, a reference numeral 201 depicts a CPU, 202 a control circuit for controlling a voltage and a clock signal, 203 a clock selection circuit for selecting a high frequency clock signal CK0 or a low frequency clock signal CK1 based on control signals SG1, SG2 supplied from the control circuit 202, and 204 a power source voltage selection circuit for selecting a high voltage V0 or a low voltage V1 based on the control signals SG1, SG2 supplied from the control circuit 202.

The control circuit 202 includes a selection section 221 for selecting resistors in accordance with the kinds of interruption factors from the CPU, the registers 222, 223, 224 for holding values corresponding to the kinds of the interruption factors from the CPU, and a decoding section 225 for decoding the value of the resistor selected by the selection section 221.

There are first, second and third interruption factors as the kinds of the interruption factors. Each of the first and third interruption factors is required to be processed by a high speed clock signal, while the second interruption factors is not required to be processed by the high speed clock signal. The registers 222, 223, 224 hold “1”, “0” and “1” as the values corresponding to the kinds of the interruption factors, respectively.

Then, the operation of the low dissipation power means will be explained. When the CPU 201 supplies a signal corresponding to the first interruption factor which is required to be processed by the high speed clock signal to the selection section 221 while the CPU is operated by the low speed clock signal, the selection section 221 selects the corresponding register 222 and supplies the value “1” of the register 222 to the decoding section 225. The decoding section 225 sets the control signals SG1, SG2 to “1”, “0”, respectively, in response to the value “1” applied thereto and outputs the control signals SG1, SG2 thus set to each of the clock selection circuit 203 and the power source voltage selection circuit 204. The clock selection circuit 203 selects the high frequency clock signal CK0 in response to the value “1” of the control signal SG1 and the value “0” of the control signal SG2 and supplies the high frequency clock signal to the CPU 201. The power source voltage selection circuit 204 selects the high voltage V0 in response to the value “1” of the control signal SG1 and the value “0” of the control signal SG2 and supplies the high voltage to the CPU 201. In this manner, the CPU 201 is supplied with the high frequency clock signal CK0 and the high voltage V0 to thereby perform the interruption processing at a high speed.

In contrast, when the CPU 201 supplies a signal corresponding to the second interruption factor which is not required to be processed by the high speed clock signal to the selection section 221 while the CPU is operated by the high speed clock signal, the selection section 221 selects the corresponding register 223 and supplies the value 0” of the register 223 to the decoding section 225. The decoding section 225 sets the control signals SG1, SG2 to “0”, “1”, respectively, in response to the value “0” applied thereto and outputs the control signals SG1, SG2 thus set to each of the clock selection circuit 203 and the power source voltage selection circuit 204. The clock selection circuit 203 selects the low frequency clock signal CK1 in response to the value “0” of the control signal SG1 and the value “1” of the control signal SG2 and supplies the low frequency clock signal to the CPU 201. The power source voltage selection circuit 204 selects the low voltage V1 in response to the value “0” of the control signal SG1 and the value “1” of the control signal SG2 and supplies the low voltage to the CPU 201. In this manner, the CPU 201 is supplied with the low frequency clock signal CK1 and the low voltage V1 to thereby perform the interruption processing at a low speed, so that the dissipation power is low.

Although dissipation power is proportional to the frequency of a clock signal, a voltage and the capacity of a circuit, in recent years, the hardware function has been increased with the high speed processing such as the pipeline processing of a CPU, the processing using a large capacity cache memory etc., so that the capacity size of the circuit tends to increase. Thus, in such a large capacity circuit, it is impossible to sufficiently reduce a dissipation power by merely reducing the frequency of the clock signal and the voltage like the prior art.

Further, the prior art has such a problem that, at the time of switching the power source voltage, since the delay characteristics of elements also transits during the voltage transition, it is difficult to assure the timing and so the reliability is degraded.

Also, the prior art has such a problem that, at the time of switching the clock signal, since the delay characteristics of elements also transits during the clock transition, it is difficult to assure the timing and so a redundant circuit is require in order to maintain the reliability.

### SUMMARY OF THE INVENTION

Accordingly, the invention has been made in order to solve the aforesaid problems of the prior art, and an object of the invention is to provide a multiprocessor apparatus which is high in reliability and can sufficiently reduce dissipation power even if circuit capacity size is large.

The multiprocessor apparatus according to the invention is provided with a high speed processor operating at a high speed; a low speed processor operating at a low speed; and activation control means for controlling activation and inactivation of each of the high speed processor and the low speed processor based on application program to be processed.

The multiprocessor apparatus further includes processing determining means for determining as to at which of the processors application program is to be processed, wherein the activation control means controls activation and inactivation of each of the high speed processor and the low speed processor based on a determination result of the processing determining means.

The multiprocessor apparatus further includes bus coupling means which couples a high speed bus for coupling the high speed processor and a low speed bus for coupling the low speed processor, wherein the bus coupling means includes switching means, coupled to a memory, for switching connection and disconnection between the memory and the high speed bus.

Further, a memory for storing data and program required for the high speed processor to process the application program is coupled to the high speed bus, and a memory for storing data and program required for the low speed processor to process the application program is coupled to the low speed bus.

The multiprocessor apparatus further includes a memory which stores data and program necessary for transferring the data and program required for the low speed processor to process the application program from the memory coupled to the high speed bus to the memory coupled to the low speed bus.

The multiprocessor apparatus further includes a DMA circuit for transferring the data and program required for the low speed processor to process the application program from the memory coupled to the high speed bus to the memory coupled to the low speed bus.

The activation control means includes clock switching means for the low speed processor to process the application program from the memory coupled to the high speed bus.

The activation control means includes clock switching means for activating and stopping clock signals for the respective processors.

The activation control means includes poser source switching means for activating and stopping power sources for the respective processors.

The low speed processor has minimum function required for processing the application program at a low speed.

The low speed processor is set in a manner that operation voltage thereof is set to a low value and a frequency of a clock signal supplied thereto is set to a small value.

The bus coupling means includes a register, wherein the bus coupling means changes contents of the register based on a result of determination of the processing determining means, and the activation control means controls an activation state of the processor based on contents of the register.

The low speed processor requires the activation control means to make the low speed processor inactivate after completion of processing of the application program.

### BRIEF DESCRIPTION OF THE DRAWINGS

FIG. 1 is a functional constitutional diagram of the multiprocessor apparatus according to a first embodiment of the invention;

FIG. 2 is an explanatory diagram showing the operation states of the respective processors in the multiprocessor apparatus according to the first embodiment of the invention;

FIG. 3 is a functional constitutional diagram of the multiprocessor apparatus according to a second embodiment of the invention;

FIG. 4 is a functional constitutional diagram of the multiprocessor apparatus according to a third embodiment of the invention;

FIG. 5 is an explanatory diagram showing the operation states of the respective processors in the multiprocessor apparatus according to the third embodiment of the invention;

FIG. 6 is another functional constitutional diagram of the multiprocessor apparatus according to the third embodiment of the invention; and

FIG. 7 is a functional constitutional diagram showing a low dissipation power means in a conventional microcomputer.

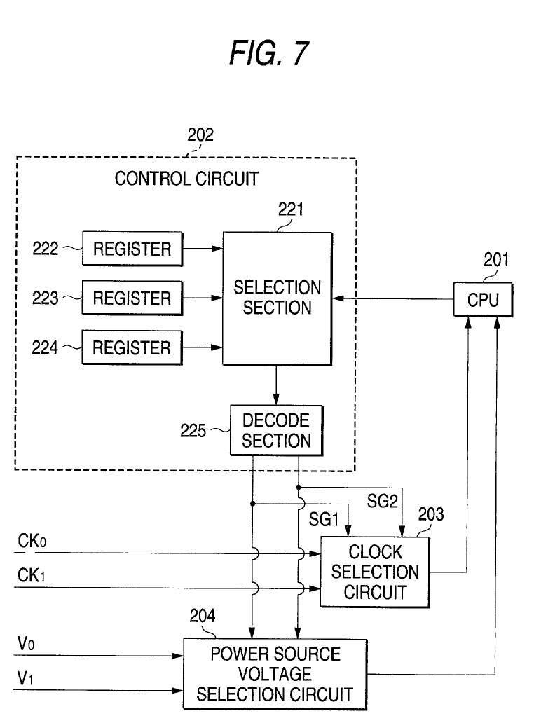

### DETAILED DESCRIPTION OF THE PREFERRED EMBODIMENTS

Now, a description will be given in more detail of preferred embodiments of the invention with reference to the accompanying drawings.

(First Embodiment)

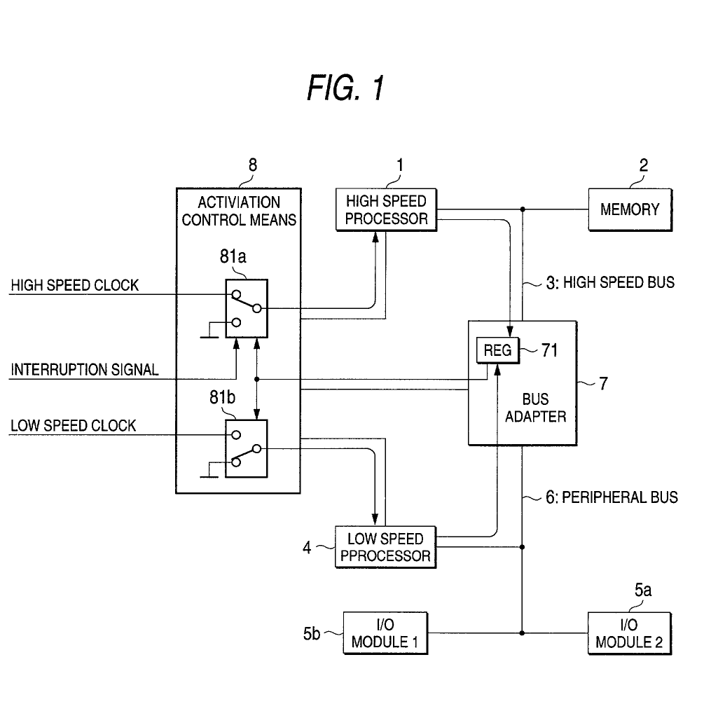

FIG. 1 is a functional constitutional diagram of the multiprocessor apparatus according to the first embodiment of the invention.

In FIG. 1, a reference numeral 1 depicts a high speed processor, 2 a memory, 3 a high speed bus for coupling the high speed processor 1 and the memory 2, 4 a low speed processor, 5a, 5b are I/O modules, 6 a peripheral bus serving as a low speed bus for coupling the low speed processor 4 and the I/O modules 5a, 5b, 7 a bus adaptor serving as a bus coupling means for coupling the high speed bus and the peripheral bus, and 8 an activation control means for controlling the operation and the stop of the high speed processor 1 and the low speed processor 4.

The high speed processor 1 is a processor with a large circuit scale capable of processing at a high speed and processing a large load.

In contrast, the low speed processor 4 is configured as a processor with a small circuit scale as compared with the high speed processor 1 in a manner that the hardware configuration thereof has no cache memory and has a reduced stage number of pipe lines. Further, the operation voltage of the low speed processor 4 is set to be lower than that of the high speed processor 1, which results in the maximum cause of the delay. However, the invention solves such a problem by setting the frequency of the clock signal of the low speed processor to be lower as well as setting the operation voltage thereof to be lower.

Further, the bus adapter 7 contains a control register 71, and the activation control means 8 includes switching sections 81a, 81b for selectively supplying clock signals to the high speed processor 1 and the low speed processor 4, respectively.

As shown in FIG. 1, according to the first embodiment, the configuration necessary for the high speed processing is coupled to the high speed bus 3 so that the high speed processing is performed by the high speed processor 1, whilst the configuration not necessary for the high speed processing is coupled to the peripheral bus 6 so that the processing is performed by the low speed processor 4. The bus adapter 7 absorbs the processing speed difference between the high speed bus 3 and the peripheral bus 6 so that the configurations coupled to the different buses can be accessed to each other.

Then, the operation of the first embodiment will be explained.

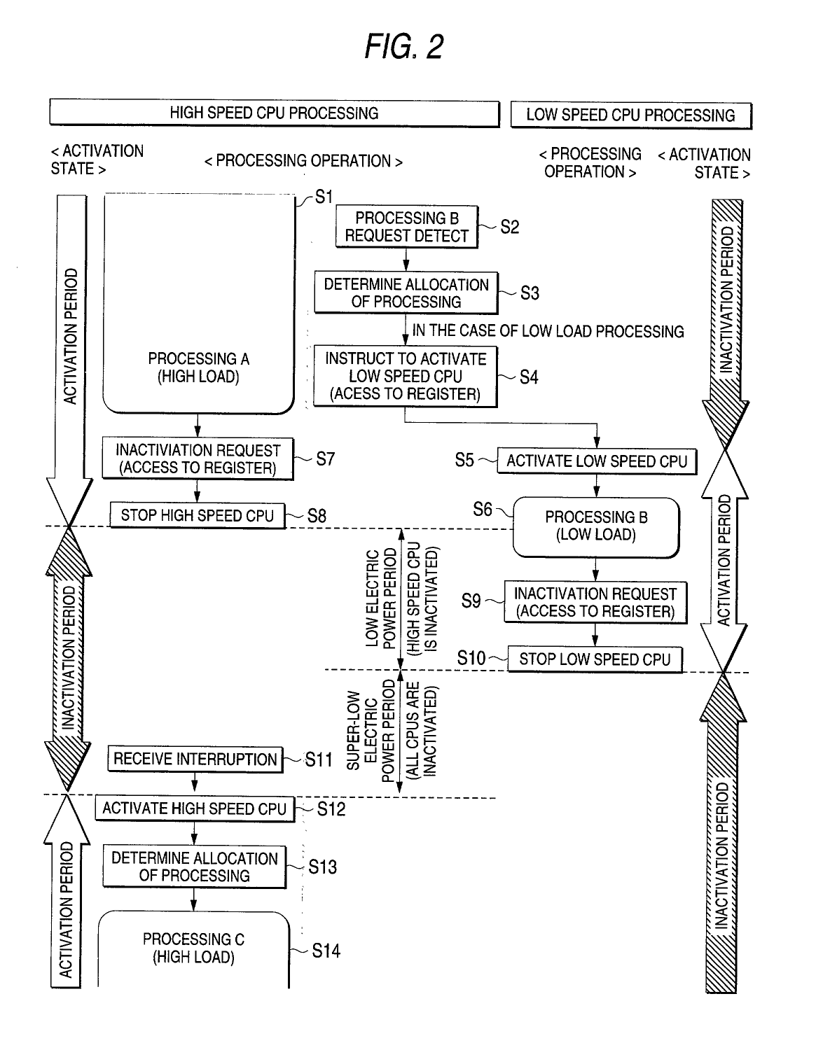

FIG. 2 is an explanatory diagram showing the operation states of the respective processors in the multiprocessor apparatus according to the first embodiment of the invention.

In the standard state, the switching section 81a of the activation control means 8 is switched to supply the high sped clock signal, while the switching section 81b is switched to stop the high speed clock signal. Thus, the high speed processor 1 reads instruction codes from the memory 2 to execute predetermined application program (S1 in FIG. 2), whilst the low speed processor 4 is not supplied with the clock signal and so placed in an inactivated state. The high speed processor 1 also accesses to the I/O modules 5a, 5b through the bus adapter 7 to control the external interfaces such as a key board, a display etc.

The application program processed by the high speed processor 1 is managed by the operation system, for example. When the execution of new application program is required by the external interruption, the timer activation etc. (S2 in FIG. 2), the operating system determines whether the new application program is to be executed by the high speed processor 1 or the low speed processor 4 (S3 in FIG. 2). As the method of the determination, there is a method that the application programs are ranked according to the loads thereof and the application program which load rank is equal to or lower than a given rank is allocated to the low speed processor 4. As another method of the determination, there is a method that the processing load is monitored in view of the number and the kinds of the application programs executed by the high speed processor 1 and the application program is allocated to the low speed processor 4 when the processing load is reduced to a level which can be executed by the low speed processor 4.

When the operating system determines that the new application program is to be executed by the low speed processor 4, the high speed processor 1 performs the write access to the register 71 of the bus adapter 7 to thereby set a bit (not shown) for the low speed processor 4 of the resister 71 to a value representing the activation (S4 in FIG. 2). A signal representing the change of the bit for the low speed processor 4 of the resister 71 to the value representing the activation is notified to the activation control means 8, whereby the switching section 81b is changed to the low speed clock signal side to thereby supply the low speed clock signal to the low speed processor 4 (S5 in FIG. 2).

The low speed processor 4 resets to thereby initialize itself in response to the clock signal supplied thereto and reads the instruction from the memory 2. The high speed processor 1 prepares initializing program to be executed by the low speed processor 4 in advance on the memory 2 so that the processing is able to jump to the new application program after the completion of the initializing program. Thus, the low speed processor 4 starts the execution of the initializing program and the new application program in accordance with the contents of the memory 2 (S6 in FIG. 2).

When the high speed processor 1 completes the processing of the application program and is placed in an idle state by allocating the new application program to the low speed processor 4, the high speed processor 1 performs the write access to the register 71 of the bus adapter 7 to thereby change a value of a bit (not shown) for the high speed processor 1 (S7 in FIG. 2). A signal representing the change of the bit value for the high speed processor of the resister 71 is notified to the activation control means 8, whereby the switching section 81a is changed to the clock signal stop side to thereby stop the supply of the clock signal to the high speed processor 1 (S8 in FIG. 2).

When the low speed processor 4 completes the execution of the application program allocated thereto, the low speed processor performs the write access to the register 71 of the bus adapter 7 to thereby set the bit for the low speed processor 4 of the resister 71 to a value representing the inactivation (S9 in FIG. 2). A signal representing the change of the bit for the low speed processor 4 of the resister 71 to the value representing the inactivation is notified to the activation control means 8, whereby the switching section 81b is changed to the clock signal stop side to thereby stop the supply of the clock signal to the low speed processor 4 (S10 in FIG. 2).

When an external factor or anew CPU processing request factor such as a timer request etc. is activated, such a factor is notified as an interruption signal (S11 in FIG. 2). The activation control means 8 monitors the interruption signal, so that the activation control means changes over the switching section 81a to the high speed clock signal side upon generation of the interruption signal to thereby activate the high speed processor 1 (S12 in FIG. 2). Thus, the high speed processor 1 is activated again from the processing after the inactivation. The high speed processor 1 is activated upon generation of the interruption signal irrespective of the value of the register 71.

Then, the operating system determines whether the application program newly generated by the interruption signal is to be executed by the high speed processor 1 or the low speed processor 4 (S13 in FIG. 2). When the operating system determines that the new application program is to be executed by the high speed processor 1, the high speed processor 1 starts the execution of the new application program (S14 in FIG. 2).

As described above, the multiprocessor apparatus according to the embodiment includes the high speed processor coupled to the high speed bus, the low speed processor coupled to the low speed bus, the bus adapter for coupling the high speed bus and the low speed bus, the operating system for determining whether the application program is to be executed by the high speed processor or the low speed processor, and the activation control means which activates the clock signal for the processor executing the application program and stops the clock signal for the remaining processor based on the determination result of the operating system. Thus, since the clock signals for the high speed processor 1 and the low speed processor 4 are stopped while the high speed processor and the low speed processor do not execute the application programs, respectively, a dissipation power of the processor to which the clock signal is not supplied can be saved. In particular, when the clock signal for the high speed processor 1 is stopped, a dissipation power can be reduced to a large extent.

In other words, since the application program of a low load etc. is allocated to the low speed processor 4 and the clock signal for the high speed processor 1 is stopped when the high speed processor 1 is placed in an idle state, the high speed processor 1 with a large dissipation power is made inactivated and so does not operate, whereby the dissipation power of the high speed processor 1 can be reduced (a low electric power period in FIG. 2).

As described above, since the low speed processor 4 is reduced in each of the circuit scale, the voltage and the clock frequency that determines a dissipation power, the low speed processor can be operated with a smaller dissipation power as compared with the high speed processor 1. Thus, a dissipation power is very small during a period where the high speed processor 1 is placed in the inactivation state and only the low speed processor 4 is operated.

Further, since the clock signal for the low speed processor 4 is stopped when the low speed processor 4 is placed in an idle state, the low speed processor 4 is made inactivated, whereby a dissipation power of the low speed processor 4 can also be saved (a super-low electric power period in FIG. 2). In this case, a dissipation power of the multiprocessor apparatus can be made minimum.

According to the first embodiment, the clock signal is not changed from the high speed to the low speed like the prior art, but the start and the stop of the clock signal for the high speed processor is performed independently from the start and the stop of the clock signal for the low speed processor, so that the multiprocessor apparatus with high reliability can be provided.

Although, in the first embodiment, the inactivation states of the processors are realized by stopping the clock signals supplied thereto, respectively, the processors may be inactivated by stopping electric power supplied them, respectively. In this case, the power source voltage is applied to the activation control means 8 in place of the clock signals and the output of the activation control means is coupled to the power sources of the high speed processor 1 and the low speed processor 4, respectively. The high speed processor 1 stores the internal state thereof as backup data in the memory in order to hold the state of the high speed processor before the stop of the electric power, and restores the state upon the re-activation thereof. Thus, a dissipation power of the processor can be made zero at the time of the inactivation state thereof.

Further, although, in the first embodiment, the activation and inactivation states of the high speed processor 1 are changed over independently from these states of the low speed processor 4, the inactivation state of the high speed processor 1 and the activation state of the low speed processor 4 may be changed over exclusively in response to the single accessing to the register 71. In this case, the operating system accesses the register 71 when the high speed processor 1 is placed in the idle state to thereby make the high speed processor 1 inactivate and the low speed processor 4 activate. Thus, the number of accessing to the register can be reduced.

Further in the first embodiment, the explanation has been made as to the case that the operating system determines whether the application program is to be executed by the high speed processor 1 or the low speed processor 4. However, the invention is not limited to this method and other methods may be employed so long as the determination is made. For example, the determination may be made by using the S/W (software) or the H/W (hardware) of the high speed processor or the S/H or the H/W provided separately from the high speed processor. In each of these methods, the effects similar to the aforesaid embodiment can be obtained.

Furthermore, although, in the first embodiment, the explanation has been made as to the case that the multiprocessor apparatus includes the single high speed processor land the single low speed processor 4, the effects similar to the aforesaid embodiment can be obtained even in the case where plural high speed processors 1 and plural low speed processors 4 are provided.

(Second Embodiment)

Although, in the first embodiment, the explanation has been made as to the case that the memory 2 is coupled to the high speed bus 3 to which the high speed processor 1 is also coupled, the second embodiment will be explained as to the case where the memory 2 is coupled through the bus adapter 7.

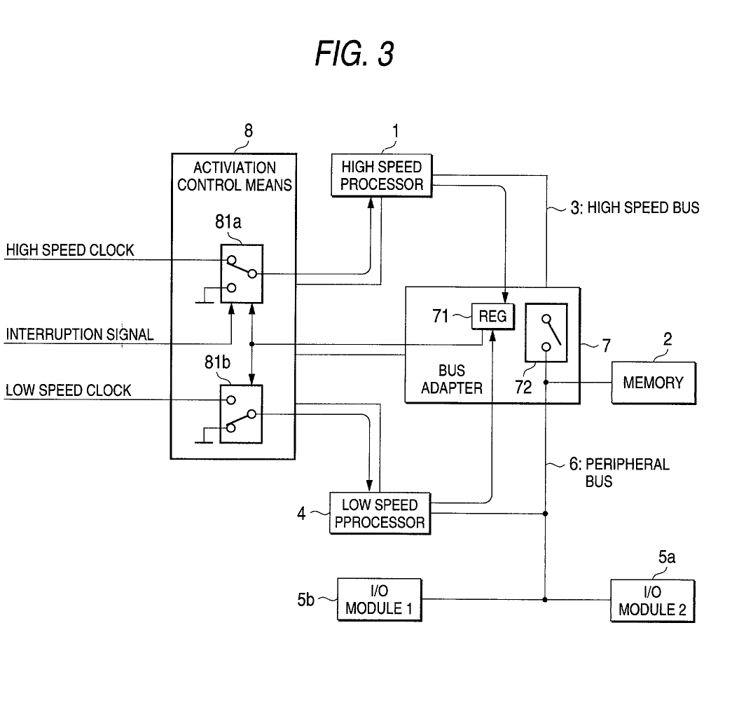

FIG. 3 is a functional constitutional diagram of the multiprocessor apparatus according to the second embodiment of the invention. The configuration of this embodiment is same as FIG. 1 except that the coupling portion of the memory 2 differs from FIG. 1 and the bus adapter 7 is has a switching means 72.

That is, in the example of FIG. 3, the memory 2 is coupled through the bus adapter 7 and also the memory 2 is always coupled to the low speed processor through the bus adapter 7. Further, although the memory 2 is coupled through the high speed bus 3 and the bus adapter 7, the memory 2 is arranged so as to be able to cut off the access from the high speed bus 3 by means of the switching means 72. In this case, the switching means 72 is turned on while the high speed processor 1 is activated and the low speed processor 4 is inactivated so that the high speed processor 1 can access to the memory 2. Further, the switching means 72 is turned off while the high speed processor 1 is inactivated and the low speed processor 4 is activated so that only the low speed processor 4 can access to the memory 2.

As explained above, since the bus adapter is coupled to the memory and has the switching means for switching the connection and disconnection between the memory and the high speed bus, the high speed bus 3 as well as the high speed processor 1 can be made inactivated when the high speed processor 1 is in the inactivation state, whereby the dissipation power of the multiprocessor apparatus can be further reduced.

(Third Embodiment)

Although, in the aforesaid embodiments, the explanation has been made as to the case that the memory 2 is shared by the high speed processor 1 and the low speed processor 4, the third embodiment will be explained as to the case where a memory for the high speed processor 1 and a memory for the low speed processor 4 are provided separately.

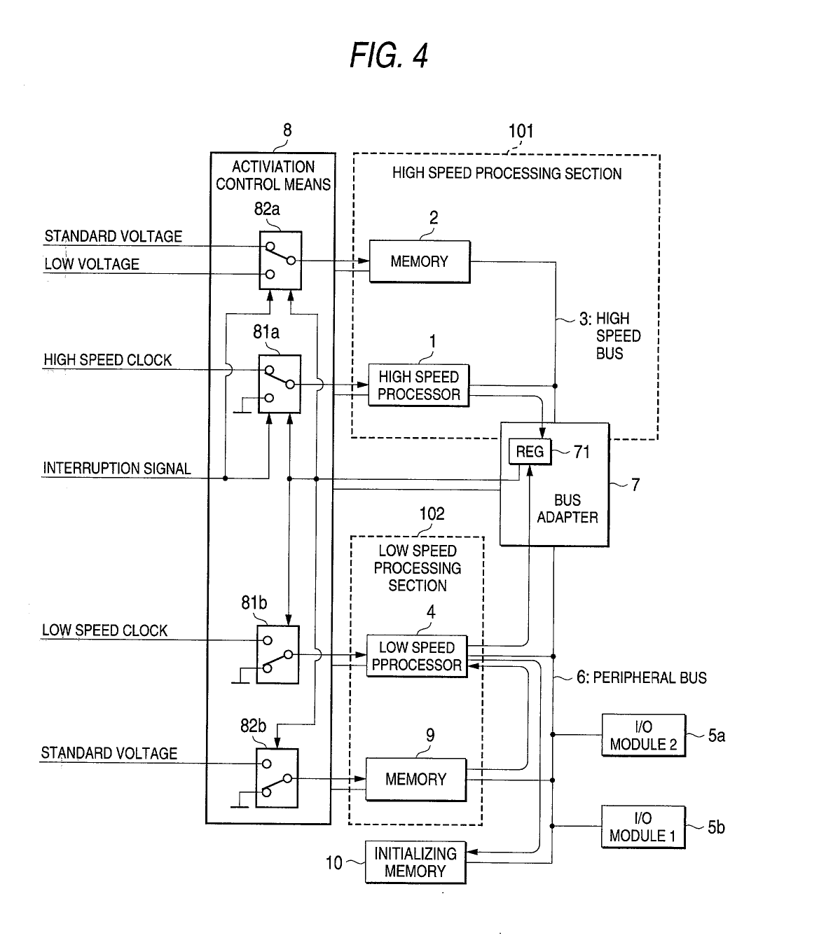

FIG. 4 is a functional constitutional diagram of the multiprocessor apparatus according to the third embodiment of the invention. In FIG. 4, a reference numeral 9 depicts a memory coupled to the peripheral bus 6; 10 an initializing memory, coupled to the peripheral bus, for storing initializing program for initializing the low speed processor 4; 82a a switching means for controlling the activation of the memory 2; 82b a switching means for controlling the activation of the memory 9; 101 a high speed processing section including the high speed processor 1, the memory 2, the high speed bus 3 and a high speed bus interface section (not shown) of the bus adapter 7; and 102 a low speed processing section including the low speed processor 4 and the memory 9.

Then, the operation of the third embodiment will be explained.

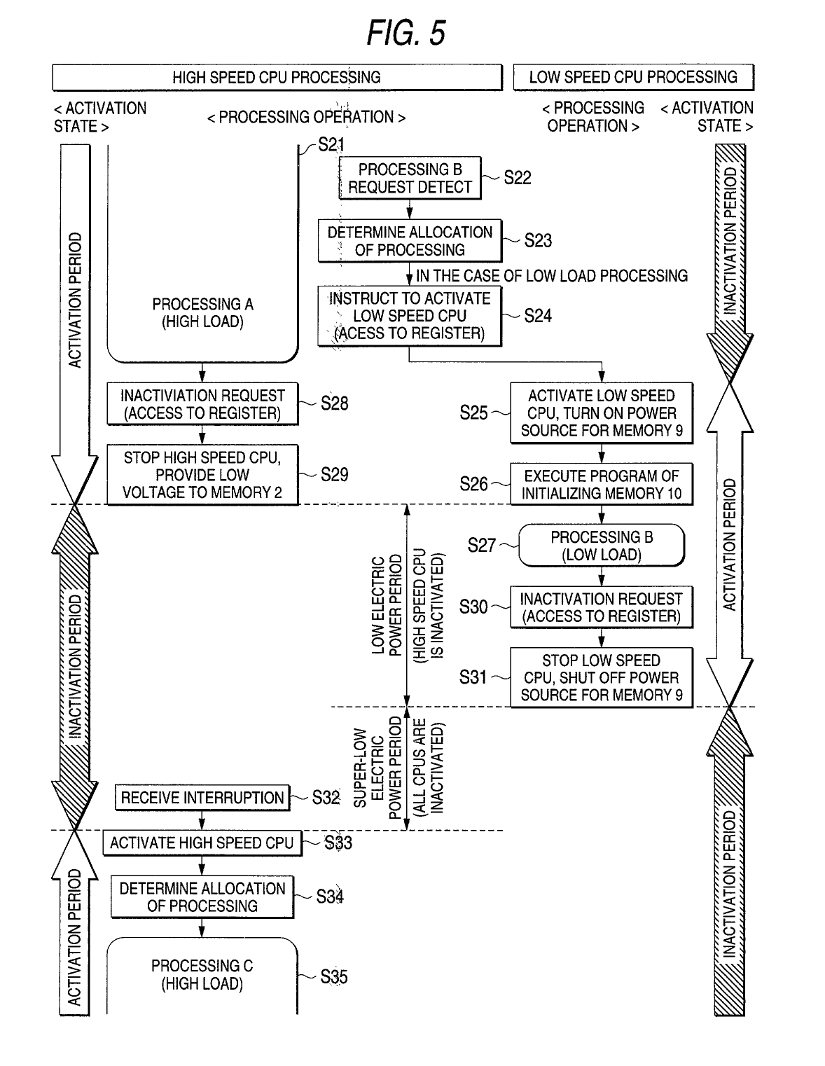

FIG. 5 is an explanatory diagram showing the operation states of the respective processors in the multiprocessor apparatus according to the third embodiment of the invention.

In the standard state, the high speed processor 1 reads instruction codes from the memory 2 to execute predetermined application program (S21 in FIG. 5). When the execution of new application program is required by the external interruption, the timer activation etc. (S22 in FIG. 5), the operating system determines whether the new application program is to be executed by the high speed processor 1 or the low speed processor 4 (S23 in FIG. 5). When the operating system determines that the new application program is to be executed by the low speed processor 4, the high speed processor 1 performs the write access to the register 71 of the bus adapter 7 to thereby set a bit (not shown) for the low speed processing section 102 to a value representing the activation (S24 in FIG. 5). A signal representing the change of the bit for the low speed processing section 102 to the value representing the activation is notified to the activation control means 8. Thus, the switching section 81b is changed to the low speed clock signal side to thereby supply the low speed clock signal to the low speed processor 4, and the switching section 82b is turned on to thereby supply electric power to the memory 9 (S25 in FIG. 5).

The low speed processor 4 executes the initializing program stored in the initializing memory 10 (S26 in FIG. 5). This program is described by instructions for transferring data and program necessary for executing the new application program to the memory 9 from the memory 2. The low speed processor 4 copies the required program and data down from the memory 2 to the memory 9 in accordance with the initializing program. After the completion of the copy, the low speed processor 4 executes the new application program in accordance with the contents of the memory 9 (S27 in FIG. 5).

When the high speed processor 1 completes the processing of the application program and is placed in an idle state by allocating the new application program to the low speed processor 4, the high speed processor 1 performs the write access to the register 71 of the bus adapter 7 to thereby change a value of a bit (not shown) for the high speed processing section 101 (S28 in FIG. 5). A signal representing the change of the bit value for the high speed processing section of the resister 71 is notified to the activation control means 8, whereby the switching section 81a is changed to the clock signal stop side to thereby stop the supply of the clock signal to the high speed processor 1 and the high speed bus 3. Further, simultaneously, the section 82a is changed to the low voltage side to thereby place the power source of the memory in such a state that the memory can hold data but can not be accessed (S29 in FIG. 5).

When the low speed processor 4 completes the processing of the allocated application program, the low speed processor performs the write access to the register 71 of the bus adapter 7 to thereby set the bit for the low speed processing section 102 to a value representing the inactivation (S30 in FIG. 5). A signal representing the change of the bit for the low speed processing section 102 to the value representing the inactivation is notified to the activation control means 8. Thus, the switching section 81b is changed to the clock signal stop side to thereby stop the supply of the clock signal to the low speed processor 4. Further, simultaneously, the switching means 82b is changed to the power source shut-off side to thereby shut-off the power supply to the memory 9 (S31 in FIG. 5).

When an external factor or a new CPU processing request factor such as a timer request etc. is activated, such a factor is notified as an interruption signal (S32 in FIG. 5). The activation control means 8 monitors the interruption signal, so that the activation control means changes over the switching section 81a to the high speed clock signal side and also changes over the switching means 82a to the standard voltage side upon generation of the interruption signal to thereby activate the high speed processing section 101 (S33 in FIG. 5). Thus, the high speed processor 1 is activated again from the processing after the inactivation. The high speed processor 1 is activated upon generation of the interruption signal irrespective of the value of the register 71.

Then, the operating system determines whether the application program newly generated by the interruption signal is to be executed by the high speed processor 1 or the low speed processor 4 (S34 in FIG. 5). When the operating system determines that the new application program is to be executed by the high speed processor 1, the high speed processor 1 starts the execution of the new application program (S35 in FIG. 5).

As described above, the memory for storing the data and the program necessary for executing the application program by the high speed processor is coupled to the high speed bus, and the memory for storing the data and the program necessary for executing the application program by the low speed processor is coupled to the low speed bus. Thus, since the high speed processing section 101 can be entirely inactivated, the dissipation power at the time of a low load can be reduced to a large extent.

That is, the application program of a low load etc. is allocated to the low speed processor 4. Further, since the high speed processing section 101 is inactivated when the high speed processor 1 is placed in the idle state, the circuit operation thereof is stopped. Thus, the dissipation power of the high speed processing section 101 including the memory 2 and the high speed bus 3 can be reduced (a low electric power period in FIG. 5).

In this respect, the memory 9 provides a capacity necessary for storing only the application program executed by the low speed processor 4, the capacity of the memory 9 is required to be small as compared with the memory 2 which stores all the application programs and the operating system. Since the memory 9 is small in its capacity which determines a dissipation power, a dissipation power of the multiprocessor apparatus is small when only the low speed processing section 102 is operated.

Further, the supply of the clock signal to the low speed processor 4 is stopped when the low speed processor 4 is placed in the idle state, so that the low speed processor 4 is made inactivated and so the dissipation power of the low speed processor 4 and the memory 9 can be saved (a super low electric power period in FIG. 5). In this case, the dissipation power of the multiprocessor apparatus can be made minimum.

Although in the third embodiment, the low speed processor 4 transfers the program to the memory 9, a DMA controller may transfer the program in place of the low speed processor. In this case, the effects similar to the third embodiment can be attained.

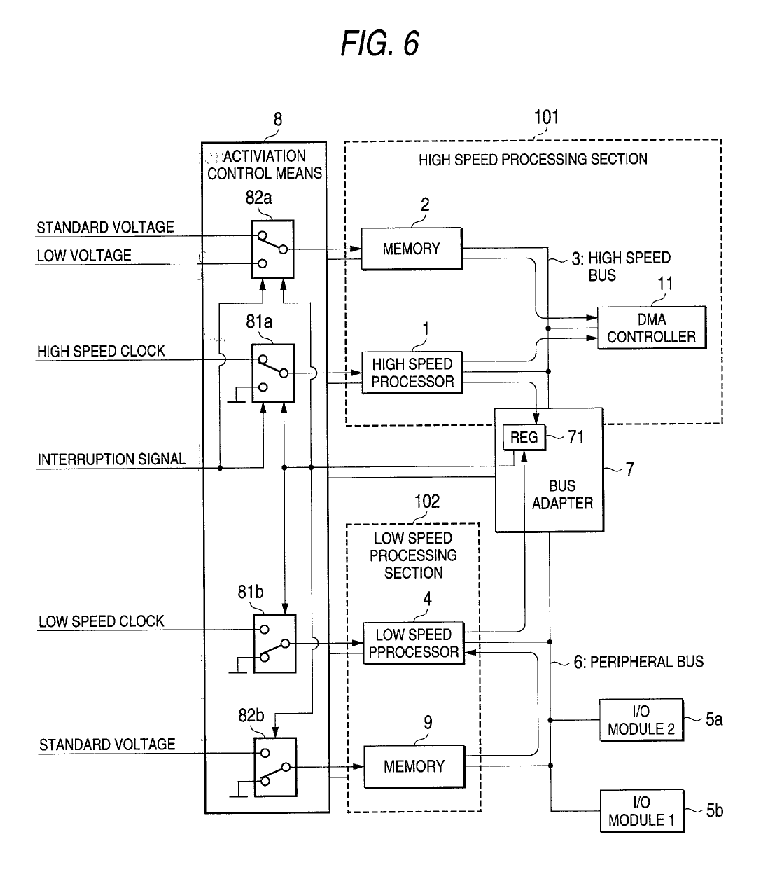

FIG. 6 is another functional constitutional diagram of the multiprocessor apparatus according to the third embodiment of the invention. The configuration of this embodiment is same as FIG. 4 except that a DMA controller 11 is added to the configuration of FIG. 4 and the initializing memory 10 is removed therefrom. The high speed processor 1 activates the DMA controller 11 so as to transfer program and data from the memory 2 to the memory 9, so that the actual transfer processing is executed by the DMA controller 11. Thus, program and data can be transferred without increasing the load of the processing of the low speed processor 4.

The similar effects can be obtained when the low speed processor 4 transfers program and data from the memory 2 to the memory 9 without using any of the DMA controller and the initializing memory 10.

As described above, according to the invention, since there is provided with the high speed processor operating at a high speed; the low speed processor operating at a low speed; and the activation control means for controlling activation and inactivation of each of the high speed processor and the low speed processor based on application program to be processed, the dissipation power of the processor placed in the inactivation state can be saved. In particular, when the high speed processor is made inactivated, the dissipation power can be reduced to a large extent.

Further, since there is provided with the high speed processor operating at a high speed; the low speed processor operating at a low speed; and the activation control means for controlling activation and inactivation of each of the high speed processor and the low speed processor based on application program to be processed, suitable processing can be performed at every application program and so the dissipation power can be reduced suitably.

Further, there is further provided with the bus coupling means which couples the high speed bus for coupling the high speed processor and the low speed bus for coupling the low speed processor, and wherein the bus coupling means includes the switching means, coupled to the memory, for switching connection and disconnection between the memory and the high speed bus. Thus, since the high speed bus can also be stopped upon stop of the high speed processing apparatus, the dissipation power can be further reduced.

Further, the memory for storing data and program required for the high speed processor to process the application program is coupled to the high speed bus, and the memory for storing data and program required for the low speed processor to process the application program is coupled to the low speed bus. Thus, since the high speed bus and the memory coupled to the high speed bus can also be stopped upon stop of the high speed processing apparatus, the dissipation power can be further reduced.

Further, there is provided with the memory which stores data and program necessary for transferring the data and program required for the low speed processor to process the application program from the memory coupled to the high speed bus to the memory coupled to the low speed bus. Thus, since the size of the program to be transferred at the time of the operation of the low speed processor can be reduced, the load of the low speed processor can be reduced.

Further, there is provided with the DMA circuit for transferring the data and program required for the low speed processor to process the application program from the memory coupled to the high speed bus to the memory coupled to the low speed bus. Thus, the processing load of the low speed processor at the time of switching the processing from the high speed processor to the low speed processor can be reduced.

The low speed processor transfers the data and program required for the low speed processor to process the application program from the memory coupled to the high speed bus. Thus, the dissipation power can be further reduced without providing a particular circuit.

The activation control means includes the clock switching means for activating and stopping the clock signals for the respective processors. Thus, since the high speed processor can be made inactivated by stopping the clock signal supplied thereto, the dissipation power can be reduced.

The activation control means includes the poser source switching means for activating and stopping the power sources for the respective processors. Thus, since the high speed processor can be made inactivated by stopping the power source therefore, the dissipation power can be reduced.

The low speed processor has minimum function required for processing the application program at a low speed. Thus, the circuit size can be reduced and so the dissipation power can also be reduced.

The low speed processor is set in a manner that operation voltage thereof is set to a low value and a frequency of a clock signal supplied thereto is set to a small value. Thus, the delay can be eliminated and the dissipation power can be reduced.

The bus coupling means includes the register, wherein the bus coupling means changes contents of the register based on a result of determination of the processing determining means, and the activation control means controls an activation state of the processor based on contents of the register. Thus, the activation state can be controlled with the simple configuration by using the software and so the dissipation power can be reduced.

The low speed processor requires the activation control means to make the low speed processor inactivate after completion of processing of the application program. Thus, the low speed processor can be stopped automatically after the completion of the processing and so the dissipation power can be reduced.

What is claimed is:

1. A multiprocessor apparatus comprising:
a high speed processor operating at a high speed;
a low speed processor operating at a low speed; and
an activation controller for controlling activation and inactivation of each of said high speed processor and said low speed processor based on application program to be processed.

2. The multiprocessor apparatus according to claim 1, further comprising a processing determining unit for determining as to at which of said processors application program is to be processed, wherein said activation controller controls activation and inactivation of each of said high speed processor and said low speed processor based on a determination result of said processing determining unit.

3. The multiprocessor apparatus according to claim 1, further comprising a bus coupling unit which couples a high speed bus for coupling said high speed processor and a low speed bus for coupling said low speed processor, wherein said bus coupling unit includes a switch coupled to a memory, for switching connection and disconnection between said memory and said high speed bus.

4. The multiprocessor apparatus according to claim 1, further comprising: a memory coupled to said high speed bus for storing data and program required for said high speed processor to process said application program; and a memory coupled to said low speed bus for storing data and program required for said low speed processor to process said application program.

5. The multiprocessor apparatus according to claim 4, further comprising a memory which stores data and program necessary for transferring said data and program required for said low speed processor to process said application program from said memory coupled to said high speed bus to said memory coupled to said low speed bus.

6. The multiprocessor apparatus according to claim 4, further comprising a DMA circuit for transferring said data and program required for said low speed processor to process said application program from said memory coupled to said high speed bus to said memory coupled to said low speed bus.

7. The multiprocessor apparatus according to claim 4, wherein said low speed processor transfers said data and program required for said low speed processor to process said application program from said memory coupled to said high speed bus.

8. The multiprocessor apparatus according to claim 1, wherein said activation controller includes a clock switch for activating and stopping clock signals for said respective processors.

9. The multiprocessor apparatus according to claim 1, wherein said activation controller includes a poser source switching for activating and stopping power sources for said respective processors.

10. The multiprocessor apparatus according to claim 1, wherein said low speed processor has minimum function required for processing said application program at a low speed.

11. The multiprocessor apparatus according to claim 1, wherein said low speed processor is set in a manner that operation voltage thereof is set to a low value and a frequency of a clock signal supplied thereto is set to a small value.

12. The multiprocessor apparatus according to claim 3, wherein said bus coupling unit includes a register, and said bus coupling unit changes contents of said register based on a result of determination of said processing determining unit, and said activation controller controls an activation state of said processor based on contents of said register.

13. The multiprocessor apparatus according to claim 1, wherein said low speed processor requires said activation controller to make said low speed processor inactivate after completion of processing of said application program.
